(19) United States
(12) Patent Application Publication
(10) Pub. No.: US 2005/0178995 A1
(43) Pub. Date: Aug. 18, 2005

(54) Structure of coating of rubber sponge materials for making objects to be used in water

(76) Inventor: Yu-Jhen Huang, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/777,270

(22) Filed: Feb. 13, 2004

(51) Int. Cl. B05D 5/00

(52) U.S. Cl. 252/8.62

(57) ABSTRACT

A coating of a rubber sponge material for a product to be used in water is provided, which coating is formed by means of applying water-soluble resin paint over a surface of the rubber sponge material such that the rubber sponge material is smooth and water-repellent, and such that a product made of the rubber sponge material won't absorb water to become heavy after it is immerged in water.

### BACKGROUND OF THE INVENTION

1. Field of the Invention

The present invention relates to a coating of a rubber sponge material for objects to be used in water, more particularly one, which is formed smooth on a rubber sponge by mean of applying water-repellent water-soluble resin paint on the rubber sponge.

2. Brief Description of the Prior Art

Rubber sponge is light in weight, and has many functions, which includes shock-proof, shock absorption, buffering, skid prevention, sound insulation, and heat insulation. Rubber sponge can be made airtight, capable or incapable of absorbing water according to the needs. Rubber sponge is widely used in computers, computer-related products, communication products, electronic instruments, automobiles, sport equipments, swimming suits, and diving suits. Diving suits can protect the wearers against sunlight, jellyfishes, and scratches of sharp rocks and acorn barnacles, and are made of rubber sponge that can't absorb water. In addition, diving suits can keep warmth and isolate low temperature because of the rubber sponge materials.

Referring to FIG. 6, conventionally cloth layers are stuck on upper and lower sides 41 and 42 of a rubber sponge material 4 for swimming suits and diving suits. The cloth layers can be knitted cloth, plain cloth, and non-woven fabrics. And, the reason why swimming suits and diving suits are conventionally provided with cloth layers is that the suits will be smoother, and easy to put on and take off owing to the cloth layers.

However, cloth layers stuck on swimming suits and diving suits made of rubber sponge are found to cause the following problems:
1. The suits made of rubber sponge are relatively elastic, and can stretch to a large degree therefore they can be easily put on and taken off. When cloth is stuck on the suits, the degree, to which the suits can stretch, will be reduced because the cloth can't stretch as much as rubber sponge.
2. The cloth will absorb water while the rubber sponge won't. Therefore, after the suits are immerged in water, the weight of the whole suits will increase. Consequently, the wearers have more weight on them, and will move slowly on the ground. In other words, the suits are not convenient to use.

### SUMMARY OF THE INVENTION

It is a main object of the present invention to provide a coating to a rubber sponge material for objects to be used in water that can overcome the above disadvantages.

The coating of the present invention is formed by means of applying water-soluble resin paint over a surface of a rubber sponge material such that the rubber sponge material is smooth and water-repellent. Consequently, swimming suits and diving suits made of the rubber sponge material can be easily put on and taken off, and won't absorb water to become heavy after they are immerged in water.

### BRIEF DESCRIPTION OF THE DRAWINGS

The present invention will be better understood by referring to the accompanying drawings, wherein:

FIG. 1 is a vertical section of the first embodiment of a rubber sponge material according to the present invention,

FIG. 2 is a vertical section of the second embodiment according to the present invention,

FIG. 3 is a vertical section of the third embodiment,

FIG. 4 is a vertical section of the fourth embodiment,

FIG. 5 is a vertical section of the fifth embodiment, and

FIG. 6 is a vertical section of the conventional rubber sponge material as described in Background.

### DETAILED DESCRIPTION OF THE PREFERRED EMBODIMENTS

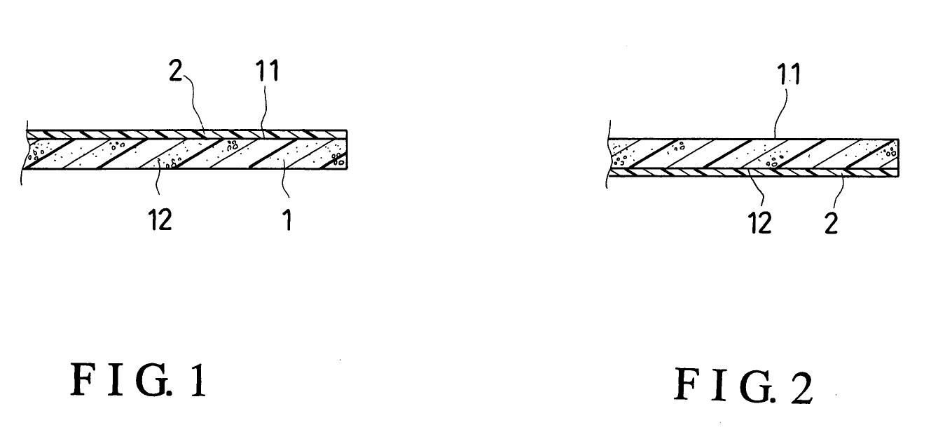

Referring to FIG. 1, in a first embodiment of the present invention, water-soluble resin paint is applied over an upper side 11 of a rubber sponge material 1 to become a coating 2, which rubber sponge material is one of thin parts cut from rubber sponge to be used as materials for objects usable in water. The rubber sponge material can be foamed chloroprene rubber (CR), foamed styrene butadiene rubber (SBR), foamed acrylonitrile butadiene rubber (NBR) or foamed ethylene propylene rubber (EPDM). And, the coating 2 includes water-soluble resin (100%), hardening agents (2 to 10%), smoothening agents (5 to 10%), anti-oxidization agents (1 to 5%), surfactants (less than 0.5%) therein, wherein the water-soluble resin (100%) can be water-soluble PU resin, water-soluble chloroprene resin (CR), water-soluble acrylic resin, water-soluble vinyl acetate resin or various mixtures of the above water-soluble resins. And, inorganic fillers (5 to 30%), and coloring agents (1 to 10%) can be added into the above ingredients according to the order. All of the ingredients are blended by means of stirring, and applied on the rubber sponge material 1.

Furthermore, the inorganic fillers can be calcium carbonate or titanium dioxide powder, the smoothening agents can be talcum powder, wax or high-class fatty acid, the coloring agents are color stains, and the anti-oxidization agents can be anti-oxidization agents containing phosphorus or anti-oxidization agents containing phenol.

The rubber sponge material 1 is dried at high temperature after water-soluble resin paint is applied on the rubber sponge material 1 such that a smooth coating 2 is formed on the surface of the rubber sponge material 1. Therefore, swimming suits and diving suits can be easily put on and taken off that are made of rubber sponge materials with the smooth coating 2 of the present invention. In addition, because the coating 2 is water-repellent, it won't absorb water to make the swimming suits and the diving suits become heavier after the suits are immerged in water.

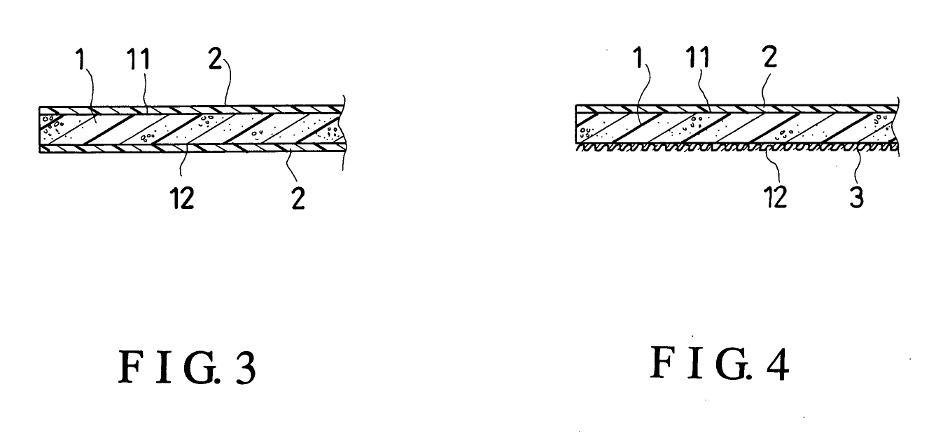

In a second embodiment of the present invention, the water-soluble resin paint is applied over a lower side 12 of a rubber sponge material 1 to become a coating 2, as shown in FIG. 2. In a third embodiment of the present invention, the water-soluble resin paint is applied over both upper and lower sides 11 and 12 of a rubber sponge material 1 to become a coating 2, as shown in FIG. 3.

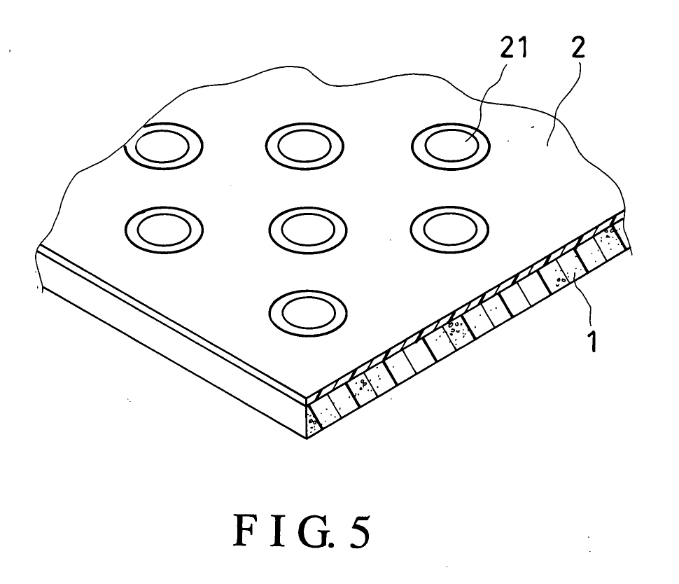

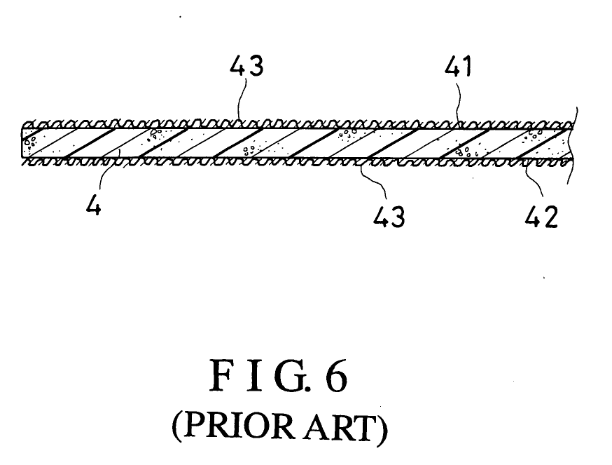

Referring to FIG. 4, the water-soluble resin paint is applied over one side 11 of a rubber sponge material 1 to become a coating 2, and a cloth 3 is stuck on the other side 12 of the rubber sponge material 1. When the rubber sponge material 1 is made into a suit to be used in water, the coating 2, which is water-repellent and won't absorb water, will face outwards while the cloth 3 will face inwards to touch the skin of a wearer of the suit.

Referring to FIG. 5, a mold is pressed against the water-soluble resin paint before and/or after the water-soluble resin paint is applied over a rubber sponge material 1 such that a coating 2 with concave and convex patterns 21 is formed on the rubber sponge material 1. And, the water-soluble resin paint can be printed with various color patterns 21 after it is applied on a rubber sponge material 1.

From the above description, it can be easily understood that the coating 2 for rubber sponge materials in the present invention has the following advantages over the conventional one:
1. In case the rubber sponge materials with the coating 2 are made into swimming suits and diving suits, the suits can be easily put on and taken off because they are smooth with the coating 2, and can slide on skins of a wearer with ease.
2. In case the rubber sponge materials with the coating 2 are made into swimming suits and diving suits, the suits will be water-repellent owing to the coating 2 of the rubber sponge materials, and won't absorb water to become heavy.
3. Most of the ingredients of the coating 2 are water-soluble resins therefore the coating 2 won't cause pollution to the environment. In other words, the coating 2 is environment-friendly.

1. A coating of a rubber sponge material for a product to be used in water, the coating being formed by means of applying water-soluble resin paint over a surface of the rubber sponge material such that the rubber sponge material is smooth and water-repellent.

2. The coating of a rubber sponge material for a product to be used in water as claimed in claimed 1, wherein the coating is formed on an upper side of the rubber sponge material.

3. The coating of a rubber sponge material for a product to be used in water as claimed in claimed 1, wherein the coating is formed on a lower side of the rubber sponge material.

4. The coating of a rubber sponge material for a product to be used in water as claimed in claimed 1, wherein the coating is formed on both upper and lower sides of the rubber sponge material.

5. The coating of a rubber sponge material for a product to be used in water as claimed in claimed 1, wherein a mold is pressed against the water-soluble resin paint before and after the paint is applied over the rubber sponge material such that the coating formed on the rubber sponge material has concave and convex patterns thereon.

6. The coating of a rubber sponge material for a product to be used in water as claimed in claimed 1, wherein the coating is printed with various color patterns.
